(19) United States
(12) Patent Application Publication
(10) Pub. No.: US 2007/0058112 A1
(43) Pub. Date: Mar. 15, 2007

(54) LIQUID CRYSTAL DISPLAY PANEL, COLOR FILTER, AND MANUFACTURING METHOD THEREOF

(76) Inventors: De-Jiun Li, Taipei County (TW); Der-Chun Wu, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,566

(22) Filed: Sep. 15, 2005

(51) Int. Cl. G02F 1/1335

(52) U.S. Cl. 349/106

(57) ABSTRACT

A liquid crystal display panel including a color filter, an active device substrate, and a liquid crystal layer is provided, wherein the liquid crystal layer is disposed between the color filter and the active device substrate. The color filter includes a substrate, a black matrix, a color filtering layer, an over-coating layer, and a transparent electrode layer. Wherein, the black matrix is disposed on the substrate to define a plurality of sub-pixel regions where the color filtering layer is disposed. In addition, the over-coating layer is disposed over the substrate to cover the black matrix and the color filtering layer. The over-coating layer has a plurality of alignment patterns, and the transparent electrode layer is disposed on the over-coating layer.

### BACKGROUND OF THE INVENTION

1. Field of the Invention

The present invention relates to a liquid crystal display panel, a color filter, and a manufacturing method thereof. More particularly, the present invention relates to a multi-domain vertical alignment (MVA) liquid crystal display panel, a color filter, and a manufacturing method thereof.

2. Description of Related Art

With the rapid improvement of semiconductor devices and man-machine interface design, the use of multi-media systems in this world is growing fast. In the past, cathode ray tube (CRT) is the choice of display because of its high display quality and low unit price. However, with our increase awareness of environmental protection, CRT no longer meets our criteria because of its bulkiness, high power consumption and possible radiation emission hazards. To resolve this issue, thin film transistor liquid crystal displays (TFT-LCD) have been developed. Because TFT-LCD is light and compact and has a high image display quality without consuming too much power, it has become one of the mainstream display products in the market.

At present, major demands for a liquid crystal display includes a high contrast ratio, a rapid response and a wide viewing angle. To provide a liquid crystal display with a wide viewing angle, the technique for producing a multi-domain vertical alignment liquid crystal display (MVA-LCD) panel is used.

FIG. 1A is a top view of a conventional MVA-LCD panel. FIG. 1B is a schematic cross-sectional view along line M-M′ in FIG. 1A. As shown in FIGS. 1A and 1B, the MVA-LCD panel 100 comprises a thin film transistor (TFT) array 110, a color filter 130 and a liquid crystal layer 150. The TFT array 110 comprises a transparent substrate 112, a plurality of scan lines 114a, a plurality of common lines 114b, an insulating layer 116, a plurality of data lines 118, a plurality of thin film transistors (TFT) 120, a passivation layer 122, and a plurality of pixel electrodes 124.

A plurality of sub-pixel regions 120a on the transparent substrate 112 are defined by the scan lines 114a and the data lines 118. Each thin film transistor 120 is disposed inside one of the sub-pixel regions 120a respectively and connected to the corresponding data line 118 and scan line 114a. In addition, the gate insulating layer 116 covers the scan lines 114a and the common lines 114b, and the passivation layer 122 is formed over the transparent substrate 112 to cover the data line 118. Besides, each pixel electrode 124 is disposed within the corresponding pixel area 120a and electrically connected to the corresponding thin film transistor 120. Each pixel electrode 124 has a plurality of alignment slits 126.

As shown in FIGS. 1A and 1B, the color filter 130 is disposed over the thin film transistor array substrate 110. The color filter 130 comprises a transparent substrate 132, a color filtering layer 133a, a black matrix 133b, an electrode layer 134 and a plurality of alignment protrusions 136. Wherein, the color filtering layer 133a and the black matrix 133b are disposed on the transparent substrate 132. In addition, the electrode layer 134 covers the color filtering layer 133a and the black matrix 133b, and the alignment protrusions 136 are disposed on the electrode layer 134. Furthermore, the liquid crystal layer 150 comprising a plurality of liquid crystal molecules 152 is disposed between the TFT array 110 and the color filter 130. Therefore, the liquid crystal molecules 152 disposed between the TFT array 110 and the color filter 130 may have a variety of tilt directions by the aid of the alignment slits 126 and the alignment protrusions 136, and the range of the viewing angle of the MVA-LCD panel 100 can be enhanced.

However, the adoption of the alignment protrusions for attaining the wide viewing angle may have the following drawbacks:

1. Due to the limitation of process, the width of an alignment protrusion may greater than 10 μm, and the height of the same may greater than 1.4 μm. With the height restriction of the alignment protrusion, the cell gap between the TFT array and the color filter needs to be greater than 3 μm.

2. The alignment protrusions would diminish part of the backlight, which leads to a decline in the brightness of the LCD panel.

3. Structure of the alignment protrusions would affect the arrangement of the liquid crystal molecules. Specifically, the liquid crystal molecules near the alignment protrusions are in abnormal arrangement, which may lead to light leakage and affect the display contrast.

In addition, referring to FIG. 2, the Japanese Patent JP2001-209065 further provides a technique, which forms grooves 81 in a color filtering layer 61 for attaining the wide view angle. Wherein, the thickness of the color filtering layer 61 is various due to the effect of the grooves 81, and the grooves 81 may also cause light leakage. Therefore, a shading layer 70 is formed correspondingly to the grooves 81 by the manufacturing process of black matrix for preventing light leakage. However, the shading layer 70 would affect the aperture ratio of the LCD panel, and the brightness thereof goes inferior.

### SUMMARY OF THE INVENTION

Accordingly, the present invention is directed to a color filter with less thickness and higher transmittance, which provides alignment effect for attaining wide view angle.

The present invention is also directed to a method for manufacturing the aforementioned color filter without any additional process or mask.

The present invention is further directed to a LCD panel with less thickness, higher transmittance, and wide view angle.

The present invention provides a color filter comprising a substrate, a black matrix, a color filtering layer, an over-coating layer, and a transparent electrode layer. The black matrix is disposed on the substrate to define a plurality of sub-pixel regions. The color filtering layer is disposed in the sub-pixel regions. The over-coating layer is disposed over the substrate to cover the black matrix and the color filtering layer, wherein the over-coating layer has a plurality of alignment patterns. The transparent electrode layer is disposed on the over-coating layer.

The present invention also provides a LCD panel, which comprises an active device array substrate, a liquid crystal layer, and the aforementioned color filter. Wherein, the active device array substrate is disposed opposite to the color filter, and the liquid crystal layer is disposed between the color filter and the active device array substrate.

According to an embodiment of the present invention, the thickness of the over-coating layer is greater than 0.5 μm.

According to an embodiment of the present invention, the alignment patterns comprise a plurality of grooves. The width of each groove may be between 1 μm and 20 μm. In addition, the depth of each groove may be greater than 0.1 μm.

According to an embodiment of the present invention, the material of the over-coating layer comprises acrylic resin or novolac resin.

According to an embodiment of the present invention, the active device array substrate is a thin film transistor array substrate. Moreover, the LCD panel may further comprise a plurality of spacers disposed between the color filter and the active device array substrate.

The present invention further provides a manufacturing method of a color filter. First, a substrate is provided. Then, a black matrix is formed on the substrate to define a plurality of sub-pixel regions. Next, a color filtering layer is formed in the sub-pixel regions. Then, an over-coating layer is formed over the substrate to cover the black matrix and the color filtering layer. Next, the over-coating layer is patterned to form a plurality of alignment patterns. Thereafter, a transparent electrode layer is formed on the over-coating layer.

According to an embodiment of the present invention, the over-coating layer is patterned by a process employing photolithography and etching.

Accordingly, the present invention forms the alignment patterns on the over-coating layer of the color filter to provide the alignment effect for attaining wide view angle. Since there are no alignment protrusions formed on the color filter, the brightness of the LCD panel can be enhanced and the light leakage can be effectively prevented.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a top view of a conventional MVA-LCD panel.

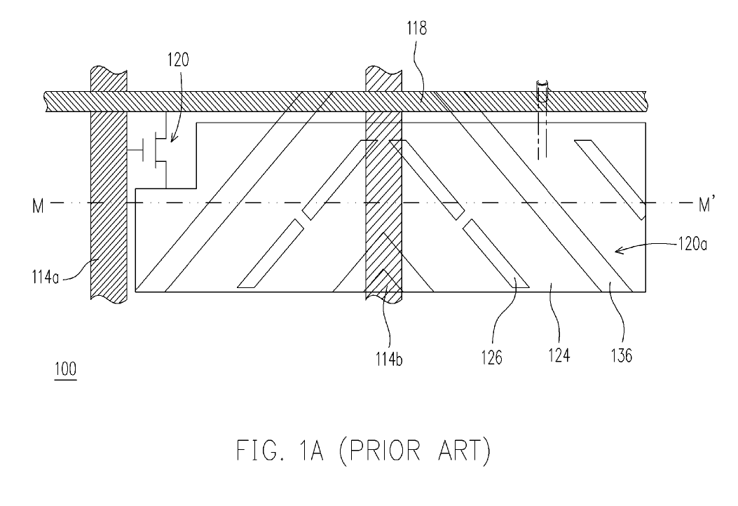

FIG. 1B is a schematic cross-sectional view along line M-M′ in FIG. 1A.

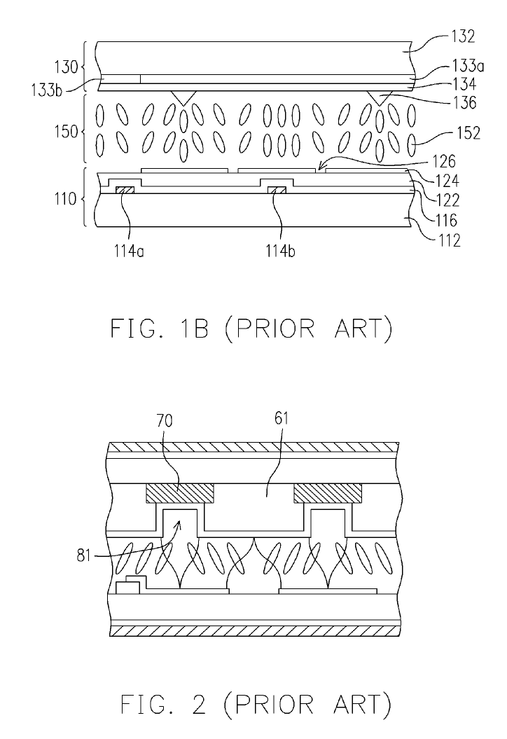

FIG. 2 is a schematic cross-sectional of another conventional MVA-LCD panel.

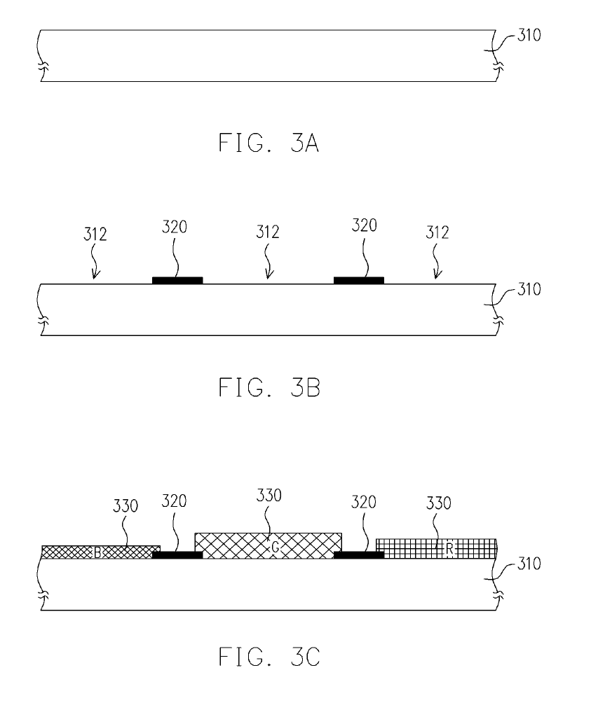

FIGS. 3A to 3F are schematic cross-sectional views illustrating a manufacturing process of a color filter according to the present invention.

FIG. 4 is a schematic cross-sectional view illustrating a LCD panel according to a preferred embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

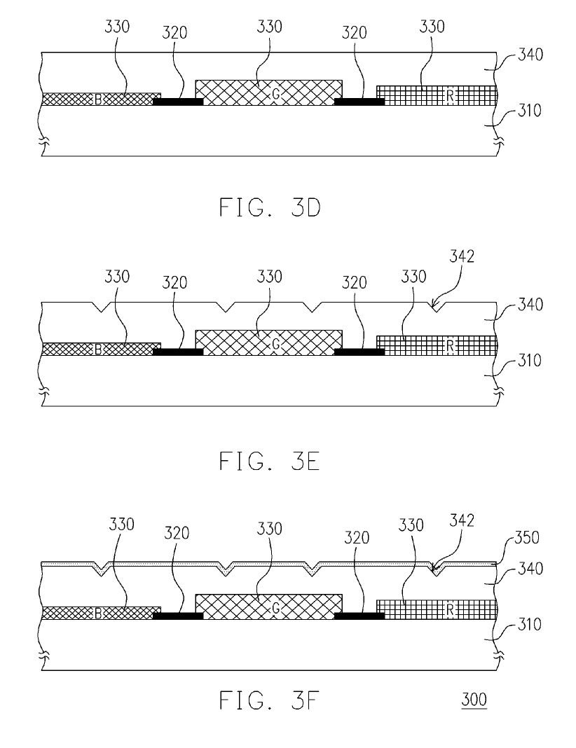

FIGS. 3A to 3F are schematic cross-sectional views illustrating a manufacturing process of a color filter according to the present invention.

First, referring to FIG. 3A, a substrate 310 is provided. The substrate may be a glass substrate, a plastic substrate, or other transparent substrates.

Next, referring to FIG. 3B, a black matrix material layer (not shown) is formed on the substrate 310. Then, a process employing photolithography or a process employing photolithography and etching is applied to the black matrix material layer to form a black matrix 320, which defines a plurality of sub-pixel regions 312 on the substrate 310. For example, the material of the black matrix 320 may be light-shading resin and thus the black matrix 320 can be formed by the process employing photolithography. In addition, the material of the black matrix 320 may be metal such as chromium. Thus the black matrix 320 can be formed by the process employing photolithography and etching.

Thereafter, referring to FIG. 3C, a color filtering layer 330 is formed in the sub-pixel regions 312 on the substrate 310 to cover the substrate 310 and a portion of black matrix 320, wherein the color filtering layer 330 may comprise a plurality of red filtering blocks (R), green filtering blocks (G), and blue filtering blocks (B). Steps of spin coating or baking can be adopted to form red, green, and blue patterned photoresist layers in different sub-pixel regions 312 sequentially. Furthermore, the color filtering layer 330 can be formed by inkjet printing or other applicable methods. The arrangement of the red, green, and blue filtering blocks of the color filtering layers 330 may be Mosaic type, stripe type, four pixels type, triangle type, etc.

Then, referring to FIG. 3D, an over-coating layer 340 is formed over the substrate 310 to cover the black matrix 320 and the color filtering layer 330. The material of the over-coating layer 340 may be acrylic resin or novolac resin. It should be noted that covering the color filtering layer 330 with the over-coating layer 340 in a specific thickness improves the material selectivity of the filtering blocks in different color. For example, high contrast and high transmittance material can be selected without considering thickness differences of different color filtering blocks. In the present invention, the thickness of the over-coating layer 340 may be greater than 0.5 μm. Preferably the thickness of the over-coating layer 340 may be 3 μm to 4 μm.

Next, referring to FIG. 3E, the over-coating layer 340 is patterned to form a plurality of alignment patterns 342 thereon. In an embodiment, the over-coating layer 340 is patterned by a process employing photolithography and etching, and the alignment patterns 342 may be grooves. For an obvious effect of wide view angle, the width of each groove may be between 1 μm and 20 μm. Preferably the width of each groove may be 6 μm to 7 μm. In addition, the depth of each groove may be greater than 0.1 μm. Preferably the depth of each groove may be 1 μm to 2 μm.

Thereafter, referring to FIG. 3F, forming a conformal transparent electrode layer 350 on the over-coating layer 340 by sputtering or other film-forming method. The manufacture of color filter 300 of the present invention is nearly accomplished. Wherein, the material of the transparent electrode layer 350 may be transparent conductive material, such as Indium Tin Oxide (ITO) or Indium Zinc Oxide (IZO).

Accordingly, the present invention forms the alignment patterns on the over-coating layer instead of the conventional alignment protrusions. Wherein, the manufacturing process of the present invention employs an amount of mask equal to the conventional process and forms no alignment protrusions on the color filter. Thus, the manufacturing cost will not increase. Furthermore, after the manufacturing process mentioned above, the color filter can be assembled with an active device array substrate to form a LCD panel.

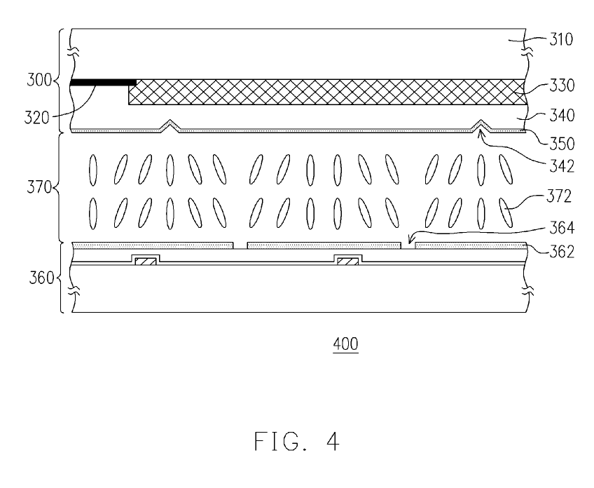

FIG. 4 is a schematic cross-sectional view illustrating a LCD panel according to a preferred embodiment of the present invention. Referring to FIG. 4, the LCD panel 400 comprises the aforementioned color filter 300, an active device array substrate, and a liquid crystal layer 370. In the embodiment, the active device array substrate may be a TFT array substrate 360, wherein pixel electrodes 362 of the TFT array substrate 360 may have a plurality of alignment slits 364. In addition, a liquid crystal layer 370 is disposed between the TFT array substrate 360 and the color filter 300, wherein the liquid crystal layer 370 has a plurality of liquid crystal molecules 372. The liquid crystal molecules 372 in the liquid crystal layer 370 may have a variety of tilt directions by the aid of the alignment slits 364 and the alignment patterns 342, and the range of the viewing angle of the LCD panel 400 can be enhanced.

Besides, before the assembly of the LCD panel 400, a plurality of spacers (not shown) may be formed between the color filter 300 and the TFT array substrate 360 for preserving the cell gap of the LCD panel 400.

In summary, the LCD panel, the color filter, and the manufacturing method of the present invention have at least the following characteristics and advantages.

1. There are no alignment protrusions on the color filter, so that the cell gap of the LCD panel can be minimized and the LCD panel becomes slim.

2. Comparing to the process of the conventional MVA-LCD panel, there needs no additional process or masks in the present invention, and thus the manufacturing cost will not increase.

3. Since the color filter has no alignment protrusions, high light transmittance is attained, and the brightness of the LCD panel can be enhanced.

4. The abnormal alignment of the liquid crystal molecules or the light leakage can be eliminated to improve the display contrast and the display quality.

5. The over-coating layer is formed on the color filtering layer to overcome the thickness differences of different color filtering blocks. Thus the material selectivity of the filtering blocks increases and the process window is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A color filter, comprising:
a substrate;
a black matrix disposed on the substrate to define a plurality of sub-pixel regions;
a color filtering layer disposed in the sub-pixel regions;
an over-coating layer disposed over the substrate to cover the black matrix and the color filtering layer, wherein the over-coating layer has a plurality of alignment patterns; and
a transparent electrode layer disposed on the over-coating layer.

2. The color filter according to claim 1, wherein the thickness of the over-coating layer is greater than 0.5 μm.

3. The color filter according to claim 1, wherein the alignment patterns comprise a plurality of grooves.

4. The color filter according to claim 3, wherein the width of each groove is between 1 μm and 20 μm.

5. The color filter according to claim 3, wherein the depth of each groove is greater than 0.1 μm.

6. The color filter according to claim 1, wherein the material of the over-coating layer comprises acrylic resin or novolac resin.

7. A liquid crystal display panel, comprising:
a color filter, comprising:
a substrate;
a black matrix disposed on the substrate to define a plurality of sub-pixel regions;
a color filtering layer disposed in the sub-pixel regions;
an over-coating layer disposed over the substrate to cover the black matrix and the color filtering layer, wherein the over-coating layer has a plurality of alignment patterns;
a transparent electrode layer disposed on the over-coating layer;
an active device array substrate opposite to the color filter; and
a liquid crystal layer disposed between the color filter and the active device array substrate.

8. The liquid crystal display panel according to claim 7, wherein the thickness of the over-coating layer is greater than 0.5 μm.

9. The liquid crystal display panel according to claim 7, wherein the alignment patterns comprise a plurality of grooves.

10. The liquid crystal display panel according to claim 9, wherein the width of each groove is between 1 μm and 20 μm.

11. The liquid crystal display panel according to claim 9, wherein the depth of each groove is greater than 0.1 μm.

12. The liquid crystal display panel according to claim 7, wherein the material of the over-coating layer comprises acrylic resin or novolac resin.

13. The liquid crystal display panel according to claim 7, wherein the active device array substrate is a thin film transistor array substrate.

14. The liquid crystal display panel according to claim 7, further comprising a plurality of spacers disposed between the color filter and the active device array substrate.

15. A manufacturing method of a color filter, comprising:
providing a substrate;
forming a black matrix on the substrate to define a plurality of sub-pixel regions;
forming a color filtering layer in the sub-pixel regions;
forming an over-coating layer over the substrate to cover the black matrix and the color filtering layer;
patterning the over-coating layer to form a plurality of alignment patterns on the over-coating layer; and
forming a transparent electrode layer on the over-coating layer.

16. The manufacturing method according to claim 15, wherein the over-coating layer is patterned by a process employing photolithography and etching.
